(19) United States
(12) Patent Application Publication
(10) Pub. No.: US 2003/0226513 A1
(43) Pub. Date: Dec. 11, 2003

(54) Bird feeder with modular bird seed reservoirs

(76) Inventors: David W. Swift, Lititz, PA (US); Edward J. Holliday, Lititz, PA (US)

Correspondence Address: JACOBSON HOLMAN PLLC, 400 SEVENTH STREET N.W., SUITE 600, WASHINGTON, DC, 20004, US

(21) Appl. No.: 10/166,070

(22) Filed: Jun. 11, 2002

(51) Int. Cl. A01K 61/02

(52) U.S. Cl. 119/57.8

(57) ABSTRACT

A gazebo-style bird feeder wherein a housing includes a plurality of modular hopper elements with a floor underlying and supporting the hopper elements and a roof overlying the hopper elements, the roof being movable relative to the floor to enable the hopper elements to be selectively removed from the housing to be cleaned, refilled or replaced when empty. The roof may simply rest on a plurality of vertical posts and be otherwise unattached to the posts with a rope having opposed ends connected to the floor and an intermediate portion passing through apertures in the roof and forming a loop for attachment to a supporting element. Each of the hopper elements is preferably rectangular in transverse cross-section, and comprises a pair of spaced, generally triangular, parallel sides interconnected by a pair of spaced, generally rectangular, sides angled from the upper portion of the hopper element to the lower portion thereof, with the parallel sides of adjacent hopper elements juxtaposed in the housing. A plurality of apertures may be defined in each of the angled sides adjacent the bottom portion of each hopper element through which birds may access bird food within the hopper element. A seed catcher may be provided underlying the lower portion of each hopper element and extending outwardly from each of the angled sides below the apertures, with a depression formed in the floor of the housing to receive the seed catchers and position the hopper elements relative to each other and relative to the housing.

### BACKGROUND OF THE INVENTION

1. Field of the Invention

This invention relates to bird feeders and relates more particularly to the type of bird feeder which comprises a housing with a hopper carried by the housing for receipt of bird food, and support for the bird feeder such as a post or a hanger for attaching the housing to a support for the bird feeder, such as a hook, a tree limb, or the like. Commonly, the hopper for bird feeders of this type comprise a cylindrical transparent plastic tube with a multiplicity of feed ports or openings intermediate the top and bottom portions of the tube. In some such bird feeders, the housing includes a wire cage surrounding the hopper to minimize access to the feed port by squirrels and other small animals.

Another common form of bird feeders commercially available are “gazebo-style” bird feeders which, like an ordinary gazebo, have a floor, a plurality of vertical supports and, ordinarily, a peaked, overhanging roof with the bird seed reservoir carried by the floor beneath the roof. Usually, the roof includes an opening with a removable cap enabling the reservoir to be refilled from above. A wire loop or the like may be attached to the housing for supporting the bird feeder in use, or the floor may be simply mounted on a post secured in the ground.

2. Description of the Related Art

Commercially available gazebo-style and other bird feeders currently on the market have several disadvantages. First, access to the bird seed hopper or reservoir through the opening in the roof is often difficult, particularly if the bird feeder is mounted at a level above the user's sight. Often, a funnel or other such implement is necessary to facilitate filling the reservoir without spilling large amounts of seed during the filling process.

Additionally, providing sources of different types of bird seed to attract a variety of birds usually requires the use of multiple bird feeders. Compartmented reservoirs or hoppers are available in some bird feeder products, but filling the individual compartments with different types of bird seed is particularly tedious.

Another problem associated with bird feeders currently available is associated with cleaning of the reservoirs. Over time, the bird food in the hopper may tend to cake or spoil from environmental moisture and heat, fouling the hopper, precluding free flow of bird seed through the access or feed apertures and necessitating removal of the reservoir from the housing. This process is especially difficult in gazebo-style bird feeders since the roof may be fixedly attached to the floor or base via the vertical posts by glue or screws. In such circumstances, removing the reservoir or hopper from the housing for cleaning and replacing the same may be impossible or, at best, is difficult and time consuming and, in some instances, requires extraneous tools such as screw drivers or the like.

### SUMMARY OF THE INVENTION

With the foregoing in mind, it is a primary object of this invention to provide a gazebo-style bird feeder which overcomes the aforementioned and other such disadvantages in a simple and inexpensive manner. More specifically, the instant invention is directed to a gazebo-style bird feeder wherein the housing includes a floor underlying and supporting a plurality of modular hopper elements, with a roof overlying the hopper elements which is movable relative to the floor to enable the hopper elements to be selectively removed from the housing to be refilled or cleaned, or to be entirely replaced by other modular hopper elements which may contain the same or different forms of bird food.

A further object of this invention is the provision of a bird feeder of the type described wherein the roof extends beyond the upper portions of the hopper elements and overhangs the floor to protect the hopper elements and the floor from the elements, with, in the preferred embodiment, the roof merely resting on the supporting posts and otherwise effectively detached from the posts so that the roof can be readily moved or removed for accessing the modular hopper elements.

Consistent with the foregoing, the housing may be supported by a post underlying the floor or, alternatively, a rope or other such element may have its opposed ends connected to the floor, with an intermediate portion passing through apertures in the roof and forming a loop for attachment to a supporting element such as a hook, a tree limb, or the like.

Yet another object of this invention is to provide a gazebo-style bird feeder with a plurality of modular hopper elements which may be readily separated from all of the housing components for ease in cleaning, refilling and/or replacement.

A further object of this invention is incorporation of a plurality of modular bird food reservoirs or hopper elements in a common gazebo-style housing wherein each of the hopper elements is generally rectangular in transverse cross-section, and comprises a pair of parallel sides interconnected by a pair of sides angled from the upper portion to the lower portion of the hopper element, with the parallel sides of adjacent hopper elements being juxtaposed in the housing, and with a plurality of apertures defined in each of the angled sides adjacent the bottom portion of each hopper element through which birds may access bird food within the reservoir.

Yet another object of this invention is the inclusion of a seed catcher underlying the lower portion of each modular hopper element and extending outwardly from each of the angled sides below the apertures to catch bird seed that escapes from the apertures in use. Additionally, the floor of the housing may include a depression dimensioned to receive the seed catchers of the hopper elements to position the hopper elements relative to each other and relative to the housing.

### BRIEF DESCRIPTION OF THE DRAWINGS

These and other objects, features and many of the attendant advantages of the invention will be better understood upon a reading of the following detailed description when considered in connection with the accompanying drawings wherein:

FIG. 1 is an exploded view of one embodiment of a gazebo-style bird feeder according to this invention, showing a pair of modular bird seed hoppers removably carried thereby;

FIG. 2 is an enlarged fragmentary cross-sectional view showing the manner in which the bird seed catcher portion of a modular hopper element seats in a depression in the floor of the housing, an optional supporting post for the bird feeder being shown in dotted lines;

FIG. 3 is a top plan view of the bird feeder of FIG. 1;

FIG. 4 is a side elevational view thereof showing the roof lifted in dotted lines for removal of one or more of the hopper elements; and

FIG. 5 is an end view of the bird feeder of this invention similar to FIG. 4.

Like reference characters refer to like parts throughout the several views of the drawings.

### DETAILED DESCRIPTION OF THE PREFERRED EMBODIMENTS

In describing a preferred embodiment of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

Referring now to the drawings, a preferred embodiment of a gazebo-style bird feeder according to the instant inventive concepts is designated generally by the reference numeral 20, and comprises basically a housing 30 and a plurality of modular hopper elements 50. Although only two such hopper elements are illustrated, the number and size of the hopper elements may obviously be increased or decreased without departing from the instant inventive concepts.

The housing 30 includes a floor 32 underlying and supporting each of the hopper elements 50 in a manner to be described in more detailed hereinafter, a plurality of upstanding posts 34, preferably fixedly secured to the corners of the floor 32 in any conventional manner, and a roof 36 overlying each of the hopper elements 50 to protect the same and the floor 32 from the elements in a well-known manner. The roof 36 may include an opening 38 covered by a removable cap 38a, if desired, to enable access to the hopper elements 50 from above, although, for many applications, such a construction will not be necessary in view of the removable nature of the hopper elements.

The foregoing housing components are preferably formed of wood for appearance sake, but can be formed of plastic or other materials, simulating a wooden gazebo. In contrast, the hopper elements are generally formed from any well known plastics material by injection molding or any other conventional manner, and may be transparent to enable the level of bird food within the individual hopper elements to be visually observed.

Preferably, the roof 36 simply rests on the upper ends 34′ of the posts 34 and is otherwise unattached to the posts. If desired, the upper ends 34′ of the posts 34 may be angled to better accommodate the angled undersurface of the roof 36 (not shown).

Although in the preferred embodiment of this invention the roof 36 is not fixedly secured to the posts 34, if desired, screws or the like (not shown) may be provided to better secure the roof to the posts, while permitting the roof to be removed when necessary for access to the modular hopper elements 50.

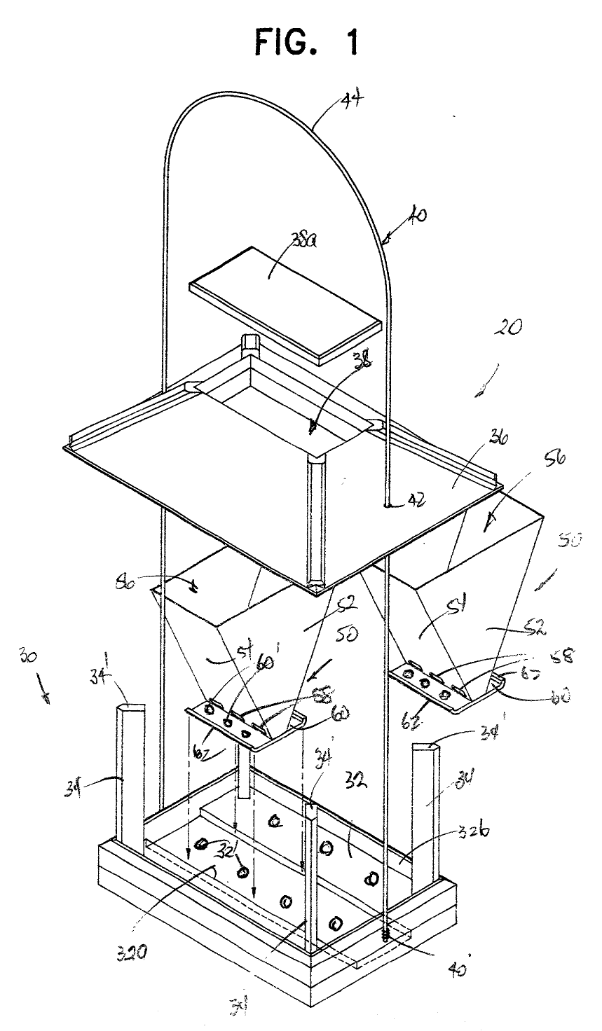

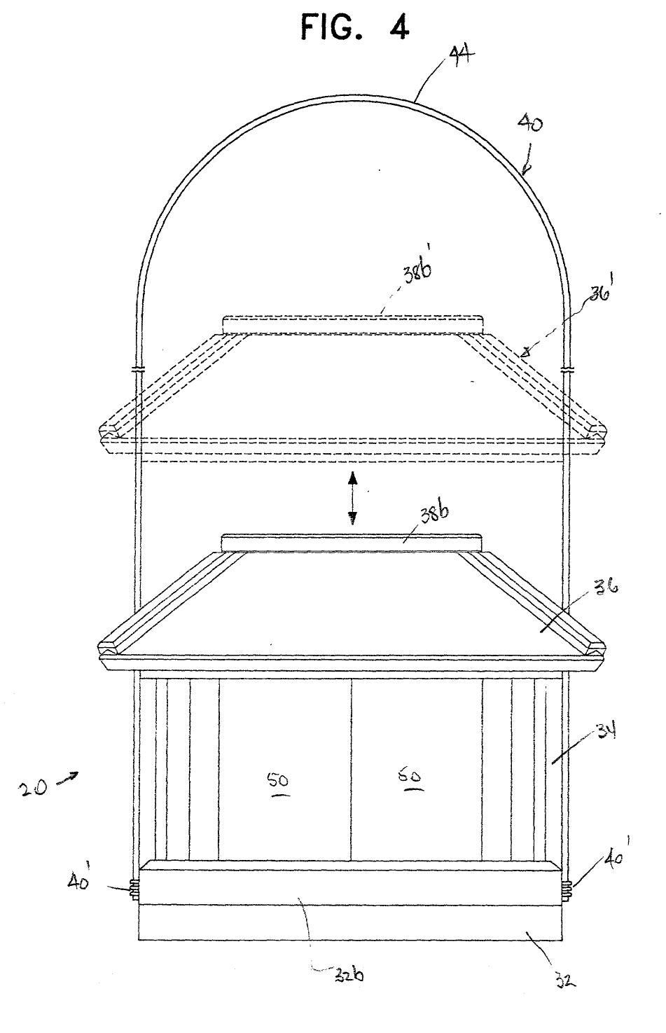

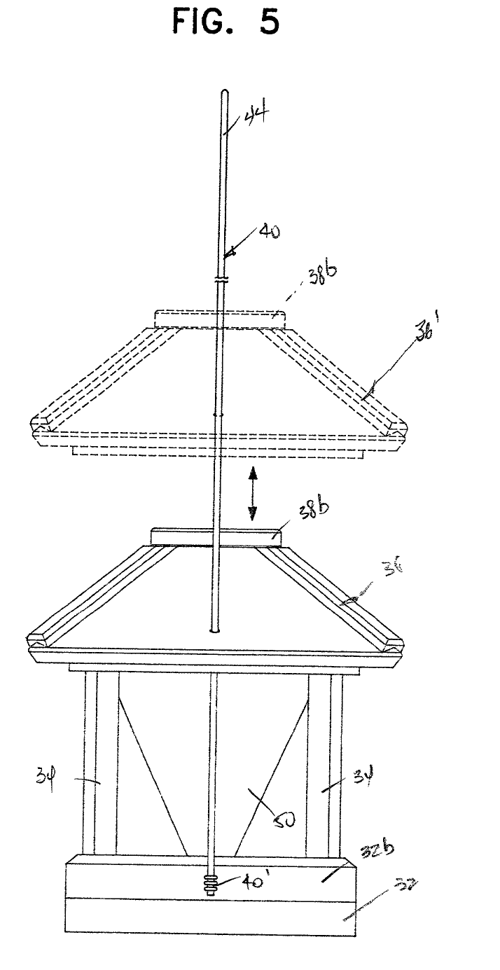

As shown in FIGS. 1, 4 and 5, a rope or cable 40 may have its opposed ends 40′ connected to the edges of the floor 32 in any conventional manner, with intermediate portions passing through apertures 42 in the roof 36 to form a loop 44 for attachment to a supporting element such as a hook, a branch of a tree or the like (not shown). In this manner, the roof 36 may be slid upwardly along the rope 40 as shown in dotted lines at 36′ in FIGS. 4 and 5 to readily access the hopper elements 50 to enable removal of the same for cleaning, refilling or replacement.

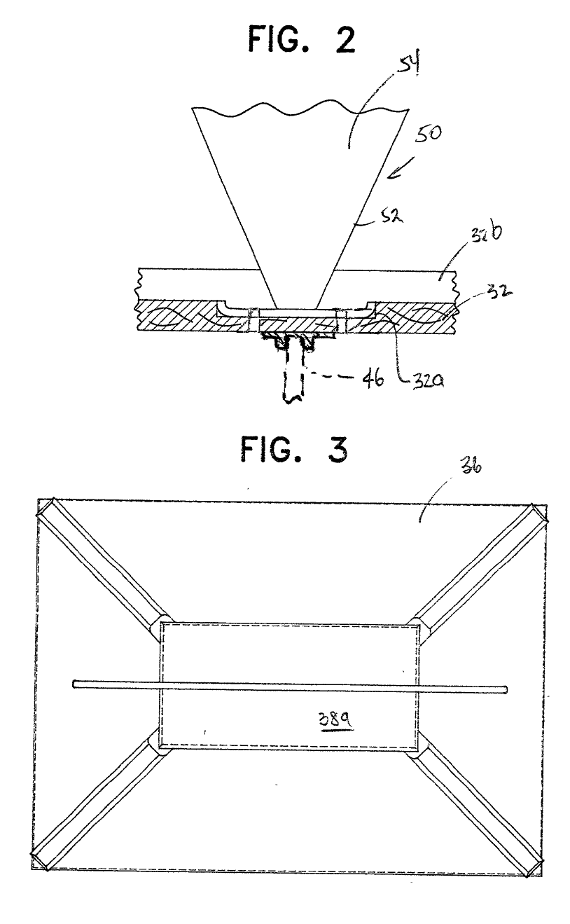

Alternatively, or additionally, a supporting post 46 may be threadably secured to the bottom of the floor 32 as seen in dotted lines in FIG. 2.

In the preferred embodiment illustrated in the drawings, each of the hopper elements 50 is rectangular in transverse cross-section, and comprises a plurality of spaced, generally triangular, parallel sides 52 interconnected by a pair of spaced, generally rectangular, sides 54 angled from the upper portion of each hopper element 50 to the lower portion thereof to provide an enlarged internal cavity or reservoir 56 for reception of a quantity of bird seed or other bird food (not shown). At the bottom of each of the angled sides 54, a plurality of apertures 58 are defined through which birds may access bird food within the reservoirs 56 in a well known manner.

A seed catcher 60 preferably underlies the lower portion of each hopper 50 and extends outwardly from each of the angled sides 54 below the apertures 58. The seed catchers 60 may have upturned edges 62 to facilitate retaining excess bird seed escaping through the apertures 58.

A depression 32a is preferably defined in the floor 32 of the housing 30, with the seed catchers 60 fitting within the depression 32a to position the hopper elements 50 relative to each other, with the parallel sides 52 of adjacent hopper elements 50 being juxtaposed within the housing 30.

A peripheral lip 32b may be provided about the floor 32 to retain bird seed or the like overflowing the seed catchers 60.

Drainage holes 60′ may be formed in the seed catchers 60 and drainage holes 32′ may be formed in the floor 32 to permit rain or water from nearby sprinklers to flow out of the bird feeder 20.

Although the bird feeder 20 is generally shown as rectangular, it is obvious that other shapes of gazebo-style bird feeders can incorporate the same inventive concepts as the embodiment shown in the drawings herein without departing from the instant inventive concepts.

The use and operation of the gazebo-style bird feeder 20 of this invention will now be readily understood by those of ordinary skill in the art. One or more modular hopper elements 50 may be pre-filled with bird food. The individual hopper elements 50 can contain the same bird food or different types of bird food to attract different birds. The size and positioning of the apertures 58 can be varied to accommodate different types of bird food.

The roof 36 of the bird feeder 20 may be moved relative to the floor 32 to enable the hopper elements 50 to be selectively positioned within the housing 30, with the seed catcher portions 60 thereof seated in the depression 32a in the floor 32 to position the hopper elements 50 relative to each other and relative to the housing 30. The bird feeder 20 can then be either supported via a post such as 46 fixed in the ground, or a rope or cable loop 44 engaged over a hook, a tree limb or the like.

When an individual hopper element is empty or needs cleaning, the roof 36 may be lifted, the modular hopper element 50 removed, cleaned, refilled, or simply replaced by a different modular element precharged with bird food. The roof 36 is then repositioned over the posts 34 of the housing 30 and ready for further use.

The foregoing descriptions and drawings should be considered as illustrative only of the principles of the invention. Numerous applications of the present invention will readily occur to those skilled in the art. Therefore, it is not desired to limit the invention to the preferred embodiments or the exact construction and operation shown and described. Rather, all suitable modifications and equivalents may be resorted to, falling within the scope of the invention.

What is claimed is:

1. A bird feeder comprising a housing and a plurality of modular hopper elements, each said hopper element having a lower portion including at least one aperture through which birds may access bird food within said hopper element, said housing including a floor underlying and supporting said hopper elements and a roof overlying said hopper elements, said roof being movable relative to said floor to enable said hopper elements to be selectively removed from said housing to be cleaned, refilled or replaced when empty.

2. The bird feeder of claim 1, further including portions of said roof extending beyond the upper portions of said hopper elements and overhanging said floor to protect said hopper elements and said floor from the elements.

3. The bird feeder of claim 2, further including a plurality of posts having lower ends carried by said floor and upper ends supporting said overhanging portions of said roof.

4. The bird feeder of claim 3, wherein said roof rests on said posts and is otherwise unattached to said posts.

5. The bird feeder of claim 3, further including a support for said housing.

6. The bird feeder of claim 5, wherein said support comprises a post underlying said floor.

7. The bird feeder of claim 5, wherein said support comprises a rope having opposed ends connected to said floor with intermediate portions passing through apertures in said roof and forming a loop for attachment to a supporting element.

8. The bird feeder of claim 1, including a plurality of said apertures spaced about said lower portion of each of said hopper elements.

9. The bird feeder of claim 1, wherein each of said hopper elements is tapered from an enlarged upper portion to its lower portion.

10. The bird feeder of claim 9, wherein each of said hopper elements is rectangular in transverse cross-section and comprises a pair of parallel sides interconnected by a pair of sides angled from said upper portion of said hopper element to said lower portion of said hopper element, said parallel sides of adjacent hopper elements being juxtaposed in said housing.

11. The bird feeder of claim 10, comprising a plurality of apertures defined in each of said angled sides adjacent said bottom portion of each hopper element.

12. The bird feeder of claim 11, further including a seed catcher underlying said lower portion of said hopper elements extending outwardly from each of said angled sides below said apertures.

13. The bird feeder of claim 12, further including a depression defined in said floor, said seed catchers fitting within said depression to position said hopper elements relative to each other and relative to said housing.

14. The bird feeder of claim 1, wherein said housing is formed of wood and said hopper elements are formed of plastic.
